(19) United States
(12) Patent Application Publication
(10) Pub. No.: US 2015/0294653 A1
(43) Pub. Date: Oct. 15, 2015

(54) Guitar Pick

(71) Applicant: John Harrington, Binghamton, NY (US)

(72) Inventor: John Harrington, Binghamton, NY (US)

(21) Appl. No.: 14/253,151

(22) Filed: Apr. 15, 2014

(51) Int. Cl. G10D 3/16

(52) U.S. Cl. CPC G10D 3/163

(57) ABSTRACT

A guitar pick that is operable to be releasably secured to a user's thumb and biased thereagainst so as to maintain a position for transition from a finger-play style of play to a pick-play style of play. The guitar pick includes a body that is planar in manner and substantially rigid. The body is formed in an asymmetrical shape so as to inhibit contact between the perimeter edge of the body and the fingers of a hand of a user during a finger-play style of play. The guitar pick further includes an aperture journaled therethrough. An attachment member is provided that is releasably secured to the body of the guitar pick by being journaled through the aperture. The attachment member forms a loop that is operable to receive a thumb and wherein the loop functions to bias the guitar pick against the thumb.

### FIELD OF THE INVENTION

The present invention relates generally to musical instruments, more specifically but not by way of limitation a stringed musical instrument playing pick that facilitates improved pick play and the ability to transition intermediate pick play method and finger play method.

### BACKGROUND

Guitar picks also known as plectrums, have been utilized for thousands of years to play guitars and/or other stringed instruments. A conventional guitar pick is shaped as an acute isosceles triangle with two generally equally rounded corners and the third corner being less rounded than the other two. The pick is made from a single durable material such as but not limited to plastic and/or wood and is utilized to strum the strings of a stringed instrument such as the guitar during play thereof.

One issue with guitar picks is that during the use thereof a player can not easily transition to other methods of play. By way of example but not by way of limitation, a guitar player typically chooses to play utilizing a pick or their fingers depending on style and/or type of music. As players transition in between the two aforementioned styles of play, it is difficult to maintain either the desired pick position and/or access to the pick so as to resume pick play ensuing finger play. Some players will use their thumb and index finger to hold the pick during pick play. Additionally other players will use their thumb and the middle finger to grasp the pick during pick play. When a player desires to transition from either of the aforementioned styles of pick play to finger play they must release the pick on order to accomplish. Conventional guitar picks provide no means for a player to retain possession thereof while engaging in finger play and subsequently providing an easy transition back to pick play.

Another issue with conventional guitar picks is their equilateral shape. Conventional guitar picks are manufactured in an acute isosceles triangular shape wherein a player will grasp proximate the shortest side thereof. As a player attempts to finger play, the shape of the conventional guitar pick inhibits free use of the index finger.

Accordingly, there is a need for a guitar pick that provides a technique to transition intermediate finger play and pick play wherein the guitar pick is able to be releasably secured to a player's thumb and maintain a perpendicular position thereto so as to be grasped when a player transitions back to pick play from finger play.

### SUMMARY OF THE INVENTION

It is the object of the present invention to provide a guitar pick that facilitates the transition from finger play to pick play and return wherein the pick is operable to be releasably secured to a user's thumb.

Another object of the present invention is to provide a guitar pick that is operable to facilitate a player's transition between pick play and finger play of a guitar wherein the pick is maintained in a generally perpendicular position to the strings.

A further object of the present invention is to provide a guitar pick that is operable to facilitate the transition between guitar play and finger play that includes an aperture therethrough.

Yet another object of the present invention is to provide a guitar pick that is operable to facilitate the transition between pick play and finger play wherein the guitar pick includes an attachment member operable to releasably secure the guitar pick to the thumb of a user.

Still a further object of the present invention is to provide a guitar pick that is operable to facilitate the transition between pick play and finger play of a guitar wherein the pick has generally planer body of equal thickness.

An additional object of the present invention is to provide a guitar pick that is operable to facilitate the transition between pick play and finger play wherein the pick has a body that is formed in a modified isosceles triangular shape.

Another object of the present invention is to provide a guitar pick having a body formed in a modified isosceles triangular shape wherein one side of the body is arcuate in manner.

To the accomplishment of the above and related objects the present invention may be embodied in the form illustrated in the accompanying drawings. Attention is called to the fact that the drawings are illustrative only. Variations are contemplated as being a part of the present invention, limited only by the scope of the claims.

### BRIEF DESCRIPTION OF THE DRAWINGS

A more complete understanding of the present invention may be had by reference to the following Detailed Description and appended claims when taken in conjunction with the accompanying Drawings wherein:

FIG. 1 is a top perspective view of the body of the present invention; and

FIG. 2 is a top view of the attachment member of the present invention; and

FIG. 3 is a perspective view of the present invention; and

FIG. 4 is a bottom view of the present invention secured to a human phalange.

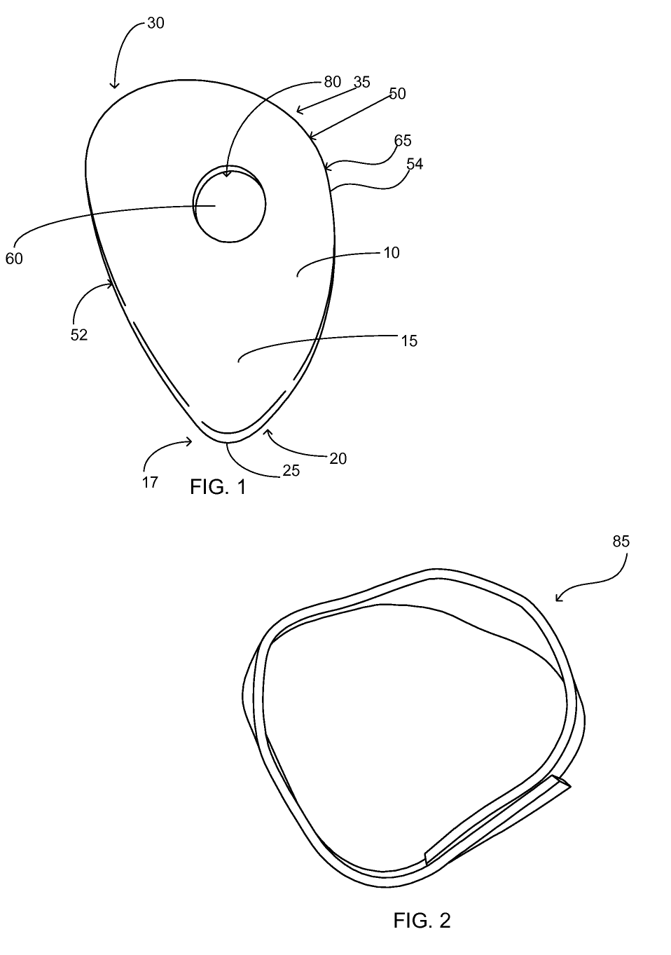

### DETAILED DESCRIPTION

Referring now to the drawings submitted herewith, wherein various elements depicted therein are not necessarily drawn to scale and wherein through the views and figures like elements are referenced with identical reference numerals, there is illustrated a guitar pick 100 constructed according to the principles of the present invention.

The guitar pick 100 further includes a body 10. The body 10 is planar in manner having a first side 15 and a second side 20 being manufactured from a suitable durable rigid material such as but not limited to plastic. The body 10 is operable to engage a stringed musical instrument such as but not limited to a guitar. The body 10 includes apex 25 proximate the lower end 17 that is rounded in manner. The apex 25 is positioned such that it is generally perpendicular with a human thumb subsequent to be releasably secured thereto as shown in particular in FIG. 4. While the apex 25 is illustrated herein as being rounded, it is contemplated within the scope of the present invention that the apex 25 could be formed with a sharper point.

The body 10 of the guitar pick 100 includes a first corner 30 that is proximate the upper end 35 of the body 10. The first corner 30 is generally rounded in manner. The body 10 has a shape that is operable to inhibit contact of the body 10 with an index finger subsequent the body 10 being secured to an exemplary thumb 99 of a user. The perimeter edge 50 of the body 10 has a first side 52 and a second side 54. The perimeter edge 50 defines the shape of the body 10 such that the body 10 is asymmetrical in shape. The benefits of the asymmetrical shape of the body 10 are further discussed herein. The first side 52 extends intermediate the first corner 30 and the apex 25. The first side 52 of the perimeter edge 50 extends towards the apex 25 in a consistent arcuate shape. The second side 54 of the perimeter edge 50 is formed such that the distance between the lower section 65 of the second side 54 and the aperture aperture midpoint 60 of the body 10 is less than that of the distance between the first side 52 and the aperture midpoint 60. The specific shape of the second side 54 and distance from the aperture midpoint 60 of the perimeter edge 50 functions to substantially inhibit contact with the index finger of a human hand subsequent the guitar pick 100 being releasably secured to the thumb of a user. As a user transitions from a pick play style wherein the strings of a guitar are being strummed using the guitar pick 100 to a finger play style, wherein the user utilizes their fingers to engage the strings of a guitar, the specific shape of the perimeter edge 50 and second side 54 of the body 10 substantially inhibits the contact of the lower section 65 of the second side 54 from contacting the index finger of a human hand to which the guitar pick 100 is secured to the thumb thereof. This is significant as it allows the user to easily transition between the style of pick play and finger play without inhibiting the user's ability during finger play.

Journaled through the body 10 proximate to the aperture midpoint 60 is aperture 80. The aperture 80 is annular in shape and is operable to receive a portion of the attachment member 85 therethrough. While the aperture 80 is illustrated as being annular herein, it is contemplated within the scope of the present invention that the aperture 80 could be formed in numerous different shapes.

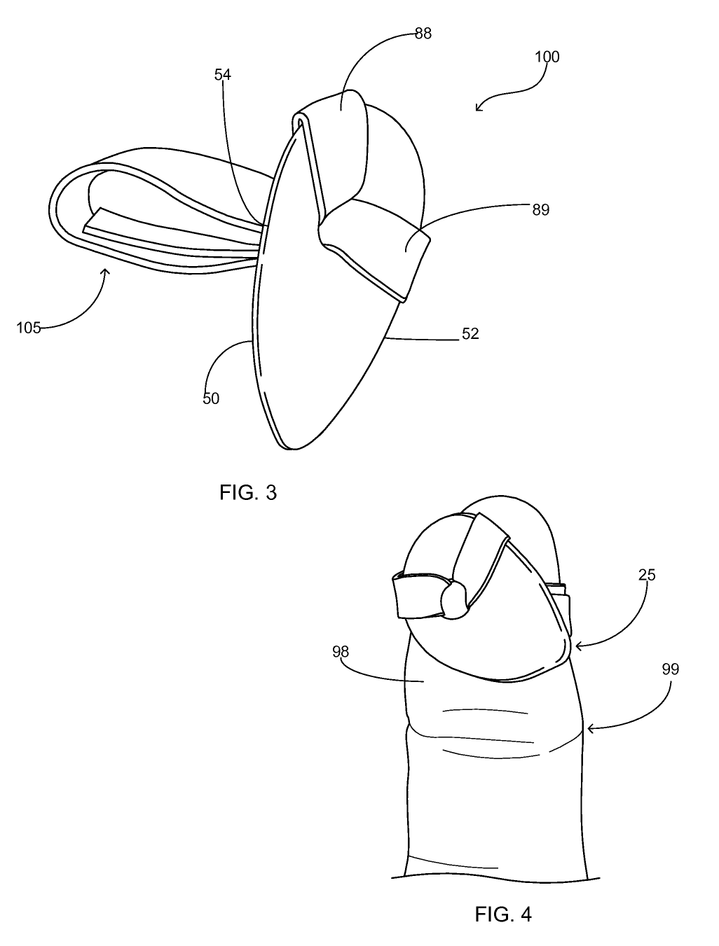

The attachment member 85 is illustrated in FIG. 2 herein. The attachment member 85 is operable to releasably secure the body 10 of the guitar pick 100 to an exemplary thumb 99 so as to maintain the guitar pick in a desirable position facilitating the transfer between playing a guitar with the guitar pick 100 and a finger play style. The attachment member 85 is manufactured from a generally resilient and elastic material such as but not limited to rubber. The attachment member 85 is formed in a circular band having a width that is suitable for journaling through the aperture 80. The attachment member 85 functions to secure the guitar pick 100 in a position such that the guitar pick 100 is adjacent the inside surface 98 of the exemplary thumb 99. This position is maintained as a user engages in a finger style play of a guitar and is yet readily available to resume a pick style play using the guitar pick 100. As shown in particular in FIG. 3, the attachment member is releasbly secured to the body 10 of the guitar pick 100 by being journaled through the aperture 80 and secured to the perimeter edge 50 forming a loop 105. The loop 105 functions to receive an exemplary thumb 99 therein so as to releasably secure the guitar pick 100 to an exemplary thumb 99 as previously discussed herein. Subsequent the operable connection of the attachment member 85 to the body 10, a portion 88 of the attachment member 85 is biased against second side 54. A second portion 89 is biased against first side 52. This configuration releasably secures the attachment member 85 to the body without the utilization of any mechanical fasteners and facilitates the easy replacement of the attachment member 85 for different size fingers or when replacement needs to occur. While the attachment member 85 is illustrated herein as being journaled through the aperture 80 of the body 10 so as to secure thereto, it is contemplated within the scope of the present invention that the body 10 could be manufactured without the aperture 80 and have the attachment member 85 secured thereto using suitable durable techniques.

In the preceding detailed description, reference has been made to the accompanying drawings that form a part hereof, and in which are shown by way of illustration specific embodiments in which the invention may be practiced. These embodiments, and certain variants thereof, have been described in sufficient detail to enable those skilled in the art to practice the invention. It is to be understood that other suitable embodiments may be utilized and that logical changes may be made without departing from the spirit or scope of the invention. The description may omit certain information known to those skilled in the art. The preceding detailed description is, therefore, not intended to be limited to the specific forms set forth herein, but on the contrary, it is intended to cover such alternatives, modifications, and equivalents, as can be reasonably included within the spirit and scope of the appended claims.

What is claimed is:

1. A pick for playing stringed musical instruments comprising:
a body, said body being planar in manner, said body being substantially rigid, said body having an upper surface and a lower surface, said body having a perimeter edge, said perimeter edge defining an asymmetrical shape for said body, said body having an apex, said apex operable to engage a stringed musical instrument.

2. The pick as recited in claim 1, and further including an apeture, said aperture being journaled through said body.

3. The pick as recited in claim 2, and futher including an attachment member, said attachment member being releasably secured to said body, said attachment member operable to releasably secure the pick to a thumb of a user.

4. The pick as recited in claim 3, wherein said attachment member is an annular band.

5. The pick as recited in claim 4, wherein said perimeter edge further includes a first side and a second side, wherein said second side is more proximate said aperture defining the asymmetrical shape of the body, wherein the asymmetrical shape of the body is operable to substantially inhibit contact with fingers of a human hand during use thereof.

6. The pick as recited in claim 5, wherein said annular band is elastic.

7. The pick as recited in claim 6, wherein said aperture is annular in shape.

8. A guitar pick operable to faciliate transition between a pick-play style and a finger-play style of playing guitar wherein the guitar pick comprising:
a body, said body being planar in manner and substantially rigid, said body having an upper surface and a lower surface, said body having a first end and a second end, said body having a perimeter edge that defines an asymmetrical shape, said body further including an apex proximate said second end, said apex operable to engage the strings of a guitar;
an aperture, said aperture being journaled through said body, said aperture being proximate said first end; and
wherein the guitar pick is releasably secured to a user's thumb so as to maintain its position against the thumb in order to faciliate use thereof for a pick-play style of guitar playing.

9. The guitar pick as recited in claim 8, and further including an attachment member, said attachment member being releasably secured to said body, said attachment member having a portion thereof journaled through said aperture.

10. The guitar pick as recited in claim 9, wherein said perimeter edge further includes a first side and a second side, said first side extending intermediate said apex and a first corner.

11. The guitar pick as recited in claim 10, wherein said second side of said perimeter edge is more proximate said aperture so as to create the asymmetrical shape of said body, wherein said asymmetrical shape substantially inibits contact with fingers of a hand during use of the guitar pick subsequent the guitar pick being releasably secured to a thumb of a user.

12. The guitar pick as recited in claim 11, wherein the attachment member has a first portion secured around a portion of said first side and a second portion secured around said second side subsequent said attachment member being secured to said body.

13. The guitar pick as recited in claim 12, wherein said attachment member further includes a loop portion, said loop portion operable to receive a thumb therethrough, said loop portion extending outward from said lower surface of said body.

14. The guitar pick as recited in claim 13, wherein said aperture is annular in shape.

15. A guitar pick operable to be releasably secured to a thumb of a user wherein the guitar pick is maintained in a biased position against the thumb so as to faciliate transition between a pick-play style and a finger-play style of playing guitar wherein the guitar pick comprises:
a body, said body being being planar in manner and substantially rigid, said body having an upper surface and a lower surface, said body having a perimeter edge defining an asymmetrical shape, said body having a first end and a second end, said perimeter edge further defining an apex proximate said second end, said apex operable to engage the strings of a guitar, said body having a first side and a second side;
a aperture, said aperture being journaled through said body proximate said first end, said aperture being annular in shape; and
wherein the asymmetrical shape of said body is operable to substantially inhibit contact with fingers on a hand of a user during a finger-style method of play of a guitar.

16. The guitar pick as recited in claim 15, and further including an attachment member, said attachment member being releasably secured to said body, wherein a portion of said attachment member is journaled through said aperture.

17. The guitar pick as recited in claim 16, wherein said attachment member further includes a loop, said loop being formed subsequent said attachment member being releasably secured to said body, said loop having an opening to receive a thumb therethrough, said loop extending outward from said lower surface of said body.

18. The guitar pick as recited in claim 17, wherein said attachment member further includes a first portion, said first portion being secured intermediate said aperture and said first side.

19. The guitar pick as recited in claim 18, wherein said attachment member further includes a second portion, said second portion being secured intermediate said aperture and said second side.

20. The guitar pick as recited in claim 19, wherein said attachment member is elastic.
